(19) United States
(12) Patent Application Publication
(10) Pub. No.: US 2007/0048557 A1
(43) Pub. Date: Mar. 1, 2007

(54) Diagnosis of cell-to-cell variability in water holdup via dynamic voltage sensor pattern in response to a cathode flow pulse

(76) Inventor: Manish Sinha, Pittsford, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/215,196

(22) Filed: Aug. 30, 2005

(51) Int. Cl. H01M 8/04

(52) U.S. Cl. 429/13; 429/23; 429/3

(57) ABSTRACT

A method for periodically removing water from cathode flow channels in a fuel cell stack that includes looking at the resulting cell voltage patterns in response to selectively pulsing the cathode airflow during. If the fuel cell stack has been in an extended low power condition for a predetermined period of time, the cathode airflow is pulsed, and the output voltage of each cell is measured to determine the difference between the cell voltages. If the cell voltages significantly vary, then the cathode airflow is pulsed more frequently, and if the cell voltages cells are sufficiently close, then the cathode air is pulsed less frequently. The propose water management diagnosis can be used in a control system to determine the frequency of cathode air pulsing.

### BACKGROUND OF THE INVENTION

1. Field of the Invention

This invention relates generally to a method for providing water management control in a fuel cell stack and, more particularly, to a method for determining how often to pulse a cathode airflow to remove water from cathode flow channels in a fuel cell stack during a sustained low power condition to provide low cell-to-cell output voltage variability.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. For the automotive fuel cell stack mentioned above, the stack may include two hundred or more fuel cells. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode reactant gas flow channels are provided on the anode side of the bipolar plates that allow the anode gas to flow to the anode side of the MEA. Cathode reactant gas flow channels are provided on the cathode side of the bipolar plates that allow the cathode gas to flow to the cathode side of the MEA. The bipolar plates also include flow channels through which a cooling fluid flows.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. During continuous low stack power demands, typically below 0.2 A/cm², water may accumulate within the flow channels because the flow rate of the reactant gas is too low to force the water out of the channels. As the water accumulates, the flow channel may close off, and the reactant gas is diverted to other flow channels because the channels are in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution, creating an unstable stack operation and reducing the overall efficiency of the fuel cell. As more and more flow channels are blocked with water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing or pulsing the reactant gas through the flow channels at a higher flow rate than is necessary to provide the desired output power. For example, it is known in the art to pulse the cathode air through the flow channels when the fuel cell stack has been continuously operating at low power demands, such as would occur when the vehicle is idling for an extended period of time. For example, the cathode air may be pulsed to a level for half stack power every 3-5 minutes. By pulsing the cathode air in this manner, water is forced out of the channels. However, the increased airflow dries the membranes causing problems with expansion and shrinkage of the membrane. Also, an increased airflow increases the parasitic power applied to the air compressor, thereby reducing overall system efficiency.

Providing water management at the stack level does not necessarily translate to water management in all of the fuel cells in the stack. In other words, the water accumulation in the cathode flow channels may affect the cell output voltages differently, which is not addressed by known fuel cell water management processes. Cell variability may be the result of tolerances, aging of the stack or other factors. The variability in the state of hydration from cell-to-cell results in various problems, such as low power instability and low performing cells. Small variability in design and assembly of cells results in different pressure drops in the cathode flow field, anode flow field and the coolant flow field. This in turn causes variability in cell stoichiometry and temperatures. The relative humidity of gases in the flow field is very sensitive to stoichiometry and temperature.

If the normal operating range of a fuel cell stack is 80-90% relative humidity, the cell-to-cell variability could result in some cells having a relative humidity over 100%, consequently flooding the cell. Moreover, when a cell partially floods it causes more pressure drop and a reduction of stoichiometry, thus resulting in a runaway condition leading to stack failure, possibly resulting in stack shutdown. The dynamics of this runaway is a function of cell-to-cell variability.

Further, as the number of cells in the stack increases, these problems compound. No matter how tight the tolerances in the cells are, there still will be variability caused by plate design, MEA variability, diffusion media variability and assembly. Thus, there is a need for operational approaches to diagnose the extent of variability in the cells and develop a remedial action to minimize or reset the variability.

### SUMMARY OF THE INVENTION

In accordance with the teachings of the present invention, a method for periodically removing water from cathode flow channels in a fuel cell stack is disclosed that includes selectively pulsing the cathode airflow during extended low power load conditions, where the frequency of the pulsing depends on the cell-to-cell output voltage variability of the fuel cells in the stack during the pulse. If the fuel cell stack has been in the extended low power condition for a predetermined period of time, the cathode airflow is pulsed, and the output voltage of each cell is measured during the pulse to determine the difference between the cell voltages. If the cell voltages significantly vary, then the cathode airflow is pulsed more frequently, and if the cell voltages cells are nearly the same, then the cathode air is pulsed less frequently.

Additional features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack;

FIG. 2 is a flow chart diagram showing a process for pulsing the cathode airflow during a low power stack output, according to an embodiment of the present invention;

FIG. 3 is a graph with cell voltage on the vertical axis and time on the horizontal axis showing the output voltage potential of each cell in a fuel cell stack where the cell-to-cell variability is large; and

FIG. 4 is a graph with cell voltage on the vertical axis and time on the horizontal axis showing the output voltage potential of each cell in a fuel cell stack where the cell-to-cell variability is small.

### DETAILED DESCRIPTION OF THE EMBODIMENTS

The following discussion of the embodiments of the invention directed to a method for determining cell output voltage variability in a fuel cell stack to determine how often the cathode airflow will be pulsed during extended low power operating conditions to remove water from the cathode flow channels is merely exemplary in nature, and is in no way intended the limit the invention or its applications or uses.

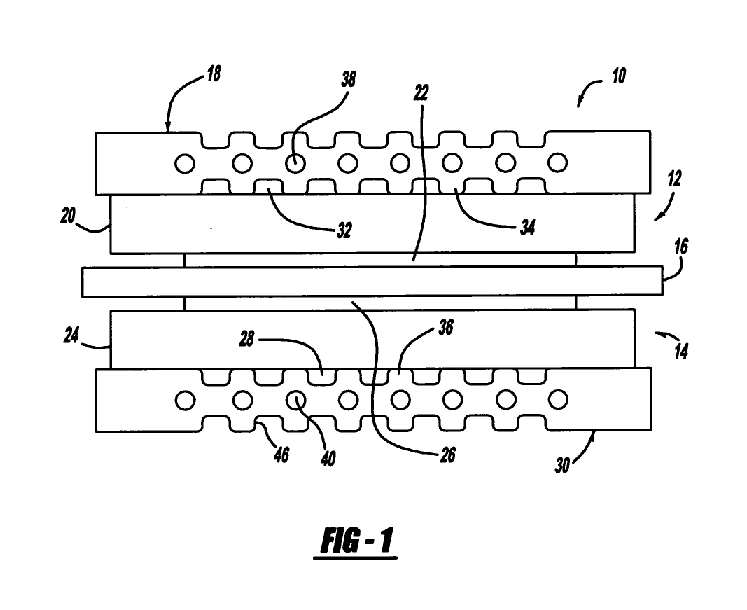

FIG. 1 is a cross-sectional view of a fuel cell 10 that is part of a fuel cell stack of the type discussed above. The fuel cell 10 includes a cathode side 12 and an anode side 14 separated by an electrolyte membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. The bipolar plates 18 and 30 are provided between the fuel cells in the fuel cell stack. A hydrogen reactant gas flow from flow channels 28 in the bipolar plate 30 reacts with the catalyst layer 26 to dissociate the hydrogen ions and the electrons. Airflow from flow channels 32 in the bipolar plate 18 reacts with the catalyst layer 22. The hydrogen ions are able to propagate through the membrane 16 where they electro-chemically react with the oxygen-in the airflow and the return electrons in the catalyst layer 22 to generate water as a by-product. The bipolar plate 18 includes lands 34 between the flow channels 32 and the bipolar plate 30 includes lands 36 between the flow channels 28. Cooling fluid flow channels 38 are provided in the bipolar plate 18 and cooling fluid flow channels 40 are provided in the bipolar plate 30.

The following discussion of the invention is directed to a process for determining the variability of the cells in a fuel cell stack. Particularly, the invention includes determining the difference between the voltage outputs of the fuel cells in a fuel cell stack based on water accumulation in the cathode side flow field channels to determine how often the cathode airflow needs to be pulsed to remove the water from the channels. When the cathode side of a fuel cell is pulsed with an increased airflow, the cell voltage responds as a result of an increase in the partial pressure of oxygen, a reduction in partial pressure of water, an increase in pressure due to an increased pressure drop and higher flows, and an increase in resistance as a result of the MEA drying. The first three factors result in an increase in cell voltage, but the fourth factor results in a decrease in-cell voltage. The overall stack voltage is a super-position of the four factors. Thus, the cell that has the higher water accumulation will take the longest to dry out, and the reduction in the voltage will be delayed or may not even show. Therefore, cells having different water accumulation show different voltage patterns in response to a cathode flow pulse.

The present invention proposes detecting cell-to-cell variation in water buffers by looking at individual voltage patterns of the cells. This can be a basis of an online diagnostic that can be used to trigger remedial action to address low power stability. For example, the primary remedial action to address low performing cells, low power and stability is to perform cathode flow pulsing. However, currently there is no diagnostics to detect, trigger or stop the cathode pulsing. The duration and height of the cathode flow pulse would depend on the properties of the diffusion media of the fuel cell. For example, as the water holding capacity of the diffusion media in the MEA decreases, the cathode flow pulse can have a lower amplitude and duration.

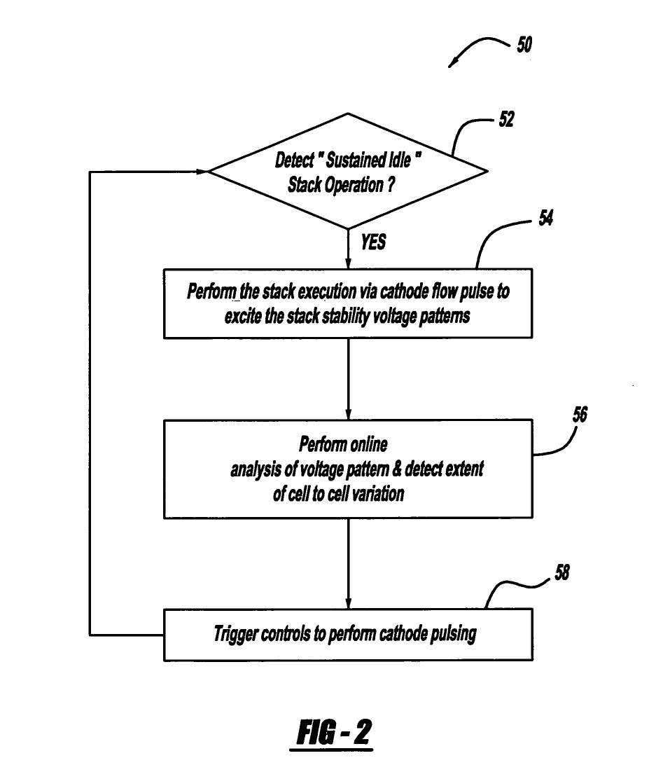

FIG. 2 is a flow chart diagram 50 showing one operation for providing cathode airflow pulses to remove water accumulated in the cathode side flow field to increase stack stability, according to an embodiment of the present invention. The algorithm first determines whether the stack is in a low power output or in a sustained idle operation for a predetermined period of time at decision diamond 52. The particular low power level and the time are application specific for different fuel cell stack designs. In one non-limiting embodiment, the stack must be outputting a stack power of about 0.2 A/cm² or less continuously for about five minutes or more. These values are application specific and would vary for different stacks. If the stack is in the sustained idle condition at the decision diamond 52, then the algorithm provides a cathode pulse airflow to excite stack stability voltage patterns at box 54. In one non-limiting embodiment, the cathode airflow is pulsed to a level that would provide about half the total output power of the stack for about twenty seconds, i.e. the pulse amplitude and duration.

The algorithm then performs online analysis of the voltage pattern of the output of each cell to detect the extent of cell-to-cell output voltage variations at box 56. FIG. 3 is a graph with time on the horizontal axis and cell voltage on the vertical axis showing a typical or representative pattern exhibited by cell voltages in a stack that has a large cell-to-cell variation in hydration, and is indicative of a stack that would have low power instability and low performing cells. Particularly, the graph includes a plurality of graph lines 60 where each graph line 60 is the output voltage of one fuel cell in the stack. A cathode airflow pulse is initiated at line 62 and ends at line 64. As is apparent, the output voltages of the cells between the lines 62 and 64 are significantly different for some of the cells indicating a large cell-to-cell variation in output voltage. In other words, some of the cells have a much higher water accumulation in the cathode flow channels than other cells.

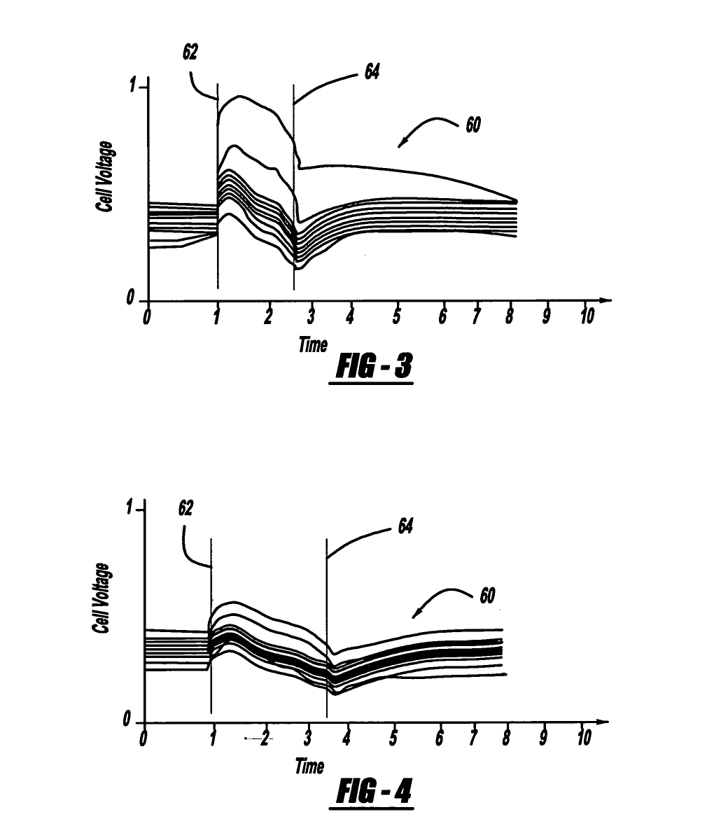

FIG. 4 shows the output voltage pattern for the cells in the stack that has been pulsed a certain number of times so that most of the water has been removed from the cathode flow channels in all of the cells, indicating a stack having low cell variability. The cell output voltages have a similar voltage pattern indicating a small cell-to-cell variation and stack stability. It should be noted that FIGS. 3 and 4 are not to sale, and are provided to show representative differences in the cell voltage dynamic pattern for stable and unstable stacks.

The algorithm looks at the voltage patterns of the cells to determine the cell-to-cell variation at box 56, and how often the cathode airflow should be pulsed during the idle condition. The algorithm can use any suitable technique for determining the difference between the cell voltages during the pulse, as would be appreciated by those skilled in the art.

The algorithm then determines how often the cathode airflow pulses will be provided to achieve a cell voltage pattern similar to that shown in FIG. 4 at box 58. For example, if the algorithm determines the variability between the cell output voltages is of the type shown in FIG. 3, then the algorithm may provide a command to pulse the cathode airflow every three minutes, during the idle period when the output power from the stack 12 is low. The voltage pattern is observed during each pulse. If this time frame of airflow pulsing eventually generates a pattern of cell output voltages of the type shown in FIG. 4, the algorithm may control the airflow pulses to be on the order of every twenty minutes, for example, or some other suitable time frame. The pulse amplitude and duration can also be controlled depending on the cell-to-cell variability. Thus, the cathode airflow is not pulsed more often than it's necessary to maintain stack stability, and thus the drying of the membranes will be minimized as a result of the cathode airflow. The values of three minutes and twenty minutes are only representative examples, and would vary from stack to stack.

The graph lines in FIGS. 3 and 4 show that different cells with different amounts of water accumulation will have different dynamic patterns in response to a cathode flow pulse. The initial peak in the cell voltages during pulsing of the cathode airflow corresponds to the increase in partial pressure of the air in the fuel cell. The dip in the cell voltage during the pulse is caused by an increase in membrane resistance as it dries out. Therefore, if a cell is flooded and has a lot of water uptake in its diffusion media layer, a cathode pulse may only dry a fraction of the water in the diffusion media layer and not dry the membrane. Consequently, that cell will not show the dip in voltages associated with the increase in membrane resistance. Therefore, the stack is maintained stable at low power outputs, without drying the stack membranes more than necessary.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing cathode reactant gas pulsing for a fuel cell stack, said method comprising:
measuring a cell output voltage of each fuel cell in the stack;
pulsing the cathode reactant gas to the stack to increase the flow rate of the cathode reactant gas; and
observing the relationship between the cell output voltages during the cathode pulse to determine cell-to-cell output voltage variation.

2. The method according to claim 1 further comprising determining how often the cathode reactant gas will be pulsed from the observation of the cell output voltages.

3. The method according to claim 2 wherein determining how often the cathode reactant gas will be pulsed includes pulsing the cathode reactant gas more often if the variations between the cell voltages indicate a unstable stack operation and pulsing the cathode reactant gas less often if the variations between the cell voltages indicate a stable stack operation.

4. The method according to claim 3 wherein the cathode reactant gas is pulsed about every three minutes for an unstable stack operation and about every twenty minutes for a stable stack operation.

5. The method according to claim 2 wherein determining how often the cathode reactant gas will be pulsed includes controlling the pulse amplitude and the pulse duration depending on whether the cell voltages indicate a stable or unstable stack operation.

6. The method according to claim 1 wherein pulsing the cathode reactant gas includes pulsing the cathode reactant gas by an amount that would provide about mid-level power from the stack.

7. The method according to claim 1 wherein pulsing the cathode reactant gas includes pulsing the cathode reactant gas if the output power of the stack is below a predetermined output power for a predetermined period of time.

8. The method according to claim 7 wherein the predetermined output power level is about 0.2 A/cm² and the predetermined time period is about five minutes.

9. The method according to claim 1 wherein the cathode reactant gas is air.

10. A method for removing accumulated water from flow channels in a fuel cell stack, said method comprising:
measuring a cell output voltage of each fuel cell in the stack;
pulsing a reactant gas to the stack to increase the flow rate of the reactant gas through the flow channels, wherein pulsing the reactant gas includes pulsing the reactant gas if the output power of the stack is below a predetermined output power for a predetermined period of time;
observing the relationship between the cell output voltages during the pulse to determine cell-to-cell output voltage variation; and
determining how often the reactant gas will be pulsed from the observation of the cell output voltages, wherein determining how often the reactant gas will be pulsed includes pulsing the reactant gas more often if the variations between the cell voltages indicate an unstable stack operation and pulsing the reactant gas less often if the variations between the cell voltages indicate a stable stack operation.

11. The method according to claim 10 wherein the reactant gas is pulsed about every three minutes for an unstable stack operation and about every twenty minutes for a stable stack operation.

12. The method according to claim 10 wherein pulsing the reactant gas includes pulsing the reactant gas by an amount that would provide about mid-level power from the stack.

13. The method according to claim 10 wherein pulsing a reactant gas includes pulsing the reactant gas if the output power level is about 0.2 A/cm² or below for a time period of about five minutes or more.

14. The method according to claim 10 wherein the flow channels are cathode flow channels and the reactant gas is air.

15. A fuel cell system, said system comprising:
a fuel cell stack including a stack of fuel cells and cathode low channels;
means for measuring a cell output voltage of each fuel cell in the stack;
means for pulsing the cathode reactant gas to the cathode flow channels to increase the flow rate of the cathode reactant gas; and
means for observing the relationship between the cell output voltages during the cathode pulse to determine cell-to-cell output voltage variation.

16. The system according to claim 15 further comprising means for determining how often the cathode reactant gas will be pulsed from the observation of the cell output voltages.

17. The system according to claim 16 wherein the means for determining how often the cathode reactant gas will be pulsed includes means for pulsing the cathode reactant gas more often if the variations between the cell voltages indicate an unstable stack operation and pulsing the cathode reactant gas less often if the variations between the cell voltages indicate a stable stack operation.

18. The system according to claim 17 wherein the means for pulsing the cathode reactant gas pulses the cathode reactant gas about every three minutes for an unstable stack operation and about every twenty minutes for a stable stack operation.

19. The system according to claim 16 wherein the means for determining how often the cathode reactant gas will be pulsed controls the pulse amplitude and the pulse duration depending on whether the cell voltages indicate a stable or unstable stack operation.

20. The system according to claim 15 wherein the means for pulsing the cathode reactant gas pulses the cathode reactant gas by an amount that would provide about mid-level power from the stack.

21. The system according to claim 15 wherein the means for pulsing the cathode reactant gas pulses the cathode reactant gas if the output power of the stack is below a predetermined output power for a predetermined period of time.

22. The system according to claim 21 wherein the predetermined output power level is about 0.2 A/cm² and the predetermined period of time is about five minutes.
